(19) United States
(12) Patent Application Publication
(10) Pub. No.: US 2020/0348135 A1
(43) Pub. Date: Nov. 5, 2020

(54) ORIENTATION DETERMINATION DEVICE AND METHOD, RENDERING DEVICE AND METHOD

(71) Applicant: Sony Semiconductor Solutions Corporation, Kanagawa (JP)

(72) Inventors: Ben EITEL, Stuttgart (DE); Daniel SCHNEIDER, Stuttgart (DE)

(73) Assignee: Sony Semiconductor Solutions Corporation, Kanagawa (JP)

(21) Appl. No.: 16/758,860

(22) PCT Filed: Oct. 26, 2018
(86) PCT No.: PCT/EP2018/079487

§ 371 Date: Apr. 24, 2020

(30) Foreign Application Priority Data
Oct. 26, 2017 (EP) 17 198 663.1

(51) Int. Cl. G01C 21/08; H04W 64/00; G06F 3/16; G01C 21/16; G01C 21/20; G01C 9/06

(52) U.S. Cl. CPC G01C 21/08; H04W 64/006; G01C 9/06; G01C 21/1654; G01C 21/206; G06F 3/16

(57) ABSTRACT

An orientation determination device comprises data input circuitry configured to obtain magnetic field sensor data comprising at least two magnetic field measurements sensed by one or more magnetic field sensors at spatially separate positions and/or in separate frequency ranges and/or at different times and/or at different codes, position input circuitry configured to obtain a position estimate of the one or more positions of the one or more magnetic field sensors, at which the magnetic field sensor data have been acquired, and estimation circuitry configured to derive, from a magnetic map, azimuth and inclination data at the one or more positions of the one or more magnetic field sensors indicated by the obtained position estimate and to estimate the orientation of the orientation determination device based on the obtained magnetic field sensor data and the azimuth and inclination data derived from the magnetic map.

### BACKGROUND

### Field of the Disclosure

The present disclosure relates to an orientation determination device and method for determining the orientation of the device. Further, the present disclosure relates to a rendering device and method for rendering target information.

### Description of Related Art

The use of today's widespread technologies for outdoor navigation may be problematic for indoor positioning and navigation mainly because of two reasons: GNSS (global navigation satellite system) signals are not available indoors and ferrous materials in the building construction heavily distort the geomagnetic field used for outdoor compass-based navigation. Further, in various applications, the orientation, i.e. heading and inclination (attitude), with respect to a reference coordinate system is of interest.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly or impliedly admitted as prior art against the present disclosure.

### SUMMARY

It is an object to provide an orientation determination device and method and a rendering device and method which allow/improve determining and using the orientation of the respective device. It is a further object to provide a corresponding computer program and a non-transitory computer-readable recording medium for implementing said methods.

According to an aspect there is provided an orientation determination device comprising:
data input circuitry configured to obtain magnetic field sensor data comprising at least two magnetic field measurements sensed by one or more magnetic field sensors at spatially separate positions and/or in separate frequency ranges and/or at different times and/or at different codes,
position input circuitry configured to obtain a position estimate of the one or more positions of the one or more magnetic field sensors at which the magnetic field sensor data have been acquired, and
estimation circuitry configured to derive, from a magnetic map, azimuth and inclination data at the one or more positions of the one or more magnetic field sensors indicated by the obtained position estimate and to estimate the orientation of the orientation determination device based on the obtained magnetic field sensor data and the azimuth and inclination data derived from the magnetic map.

According to a further aspect there is provided a rendering device comprising
one or more magnetic field sensors configured to sense magnetic field sensor data comprising at least two magnetic field measurements sensed at spatially separate positions and/or in separate frequency ranges, and
an orientation determination device as disclosed herein to determine orientation information indicating the orientation of the rendering device,
position input circuitry configured to obtain a position estimate of the rendering device,
target position input circuitry configured to obtain target position information indicating a target position of one or more targets,
relative target position determination circuitry configured to determine the relative position of the one or more targets with respect to the rendering device based on the orientation information, the obtained position estimate and the obtained target position information, and
rendering circuitry configured to render target information related to the one or more targets using the determined relative position of the one or more targets.

According to still further aspects corresponding method, a computer program comprising program means for causing a computer to carry out the steps of the methods disclosed herein, when said computer program is carried out on a computer, as well as a non-transitory computer-readable recording medium that stores therein a computer program product, which, when executed by a processor, causes the methods disclosed herein to be performed are provided.

Embodiments are defined in the dependent claims. It shall be understood that the disclosed methods, the disclosed computer program and the disclosed computer-readable recording medium have similar and/or identical further embodiments as the claimed devices and as defined in the dependent claims and/or disclosed herein.

One of the aspects of the disclosure is to estimate, for devices located in a building, the orientation of the orientation determination device with respect to a specified reference coordinate system with the use of magnetic field information that stems from the magnetic sensor and a pre-recorded magnetic map of the building (area). This way either sensor cost and/or power consumption can be reduced (e.g. since no gyroscope and/or accelerometer data are needed) or the accuracy of the orientation estimation increased in terms of a sensor fusion process (when also gyroscope and/or accelerometer data are available). This technology is especially suited for mobile and wearable battery-driven devices as the involved sensors and computations can be realized with very low power consumption. The orientation estimate can be used for a wide range of applications ranging from “enhanced” compass-like navigation (direction+distance to target) to realizing virtual sound sources (targets) in a 2D/3D area independent of the user or device position and orientation (sound sources appear in static locations independent of head orientation and user position: augmented reality (AR) sound).

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows a diagram illustrating coordinate definitions of a magnetic field vector,

FIG. 2 shows a schematic diagram of a first embodiment of an orientation determination device according to the present disclosure,

FIG. 3 shows a schematic diagram of a first embodiment of a rendering device according to the present disclosure,

FIG. 4 shows an exemplary magnetic map indicating the location-dependent azimuth distortion,

FIG. 5 shows a diagram illustrating device orientation,

FIG. 6 shows a schematic diagram of a second embodiment of an orientation determination device according to the present disclosure,

FIG. 7 shows a schematic diagram of a third embodiment of an orientation determination device according to the present disclosure,

FIG. 8 shows a schematic diagram of a fourth embodiment of an orientation determination device according to the present disclosure,

FIG. 9 shows a schematic diagram of a fifth embodiment of an orientation determination device according to the present disclosure,

FIG. 10 shows a schematic diagram of a sixth embodiment of an orientation determination device according to the present disclosure,

FIG. 11 shows a diagram illustrating a first application scenario of the disclosed devices and methods,

FIG. 12 shows a schematic diagram of a second embodiment of a rendering device according to the present disclosure for use in the application scenario shown in FIG. 11, and

FIG. 13 shows a schematic diagram of a third embodiment of a rendering device according to the present disclosure for use in a second application scenario.

### DETAILED DESCRIPTION OF THE EMBODIMENTS

Before details of the present disclosure will be described, some definitions shall be given. The term “magnetic map” refers to either the magnetic map (comprising magnetic fingerprints) of a whole area, preferably indoors such as a building, or a sub-part of the magnetic map of the whole area, e.g. a sub-part of the building, such as a floor or a wing of the building. A magnetic map for use in the embodiments disclosed herein, or a suitable sub-part of the magnetic map, respectively, comprises magnetic fingerprints of a region around the magnetic field sensor. It can be selected based on a current position of the magnetic field sensor, for example a given position estimate and, optionally, its assumed confidence (e.g. estimated position accuracy), or by a user downloading a suitable magnetic map from a server, etc.

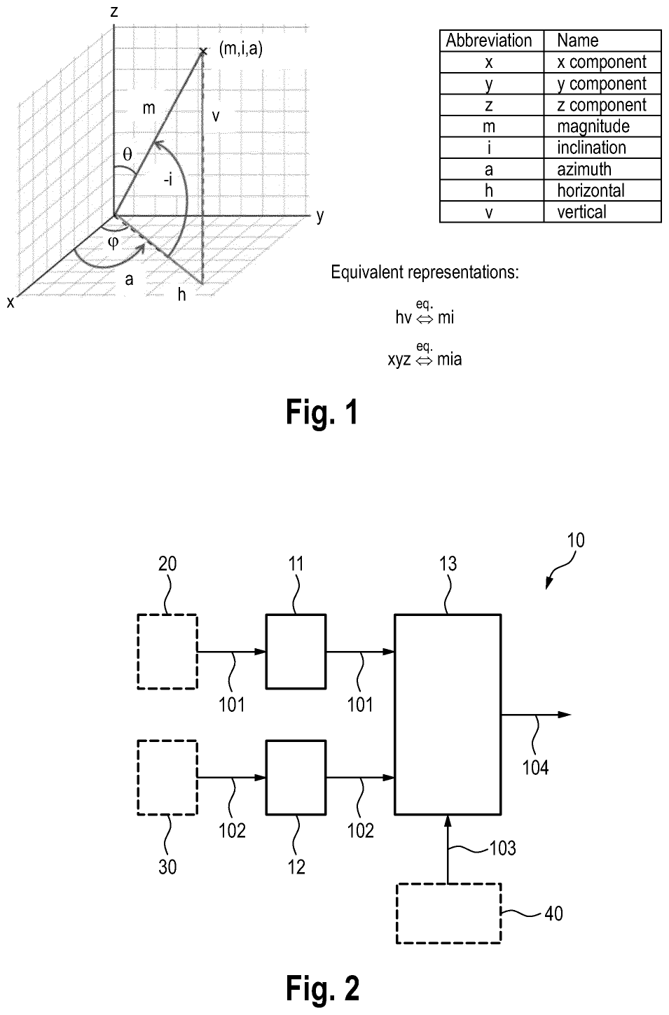

Magnetic field sensor data may, for example, be magnetic flow densities in x, y, and z directions of the magnetic field sensor's local coordinate system (i.e. in sensor coordinates) for a 3D sensor. An illustration of different representations of the magnetic field vector is shown in FIG. 1 illustrating coordinate definitions of a magnetic field vector. Example features of the magnetic field vector are magnetic field magnitude m, magnetic field inclination i, magnetic field azimuth a, magnetic field vertical component v, magnetic field horizontal component h, magnetic field Cartesian components (x, y, z) and their combinations. For example, the magnetic field vector may be represented by the feature magnetic field horizontal component h and magnetic field vertical component v. Alternatively, a representation by the feature magnetic field magnitude m and magnetic field inclination i can be used. For some situations, a further alternative representation by the magnetic field magnitude m, the magnetic field inclination i and the magnetic field azimuth a or a representation by the Cartesian components x, y and z may be chosen.

The magnitude of the geomagnetic field (sometimes also referred to as magnetic field vector) is simple to derive from a magnetic field measurement, e.g. by a magnetic field sensor, which process does generally not include any additional estimation process. Therefore, it is the most reliable information for geomagnetic fingerprinting. Unfortunately, similar magnitude values can often be found at different locations of the building, i.e. a geomagnetic field measurement can be assigned to several locations in the building with similar likelihood if only magnitude is considered and a corresponding one-dimensional feature vector is used.

The inclination of the geomagnetic field can be computed based on the magnetic field measurement and the direction of the earth's gravity field, which may be measured by an accelerometer. Aside from gravity, the accelerometer can also measure all other accelerations of the mobile/wearable device. Separation of the different acceleration sources is difficult and introduces errors to the estimation of the gravity direction. This in turn degrades the estimation accuracy of the geomagnetic field inclination. Nonetheless, this information can be used together with the magnitude of the geomagnetic field to obtain a two-dimensional feature vector for geomagnetic fingerprinting. Using the two-dimensional feature vector (fingerprint) reduces the amount of position ambiguities, as magnitude and inclination of the magnetic field are widely uncorrelated.

The azimuth information is more difficult to obtain as input for geomagnetic fingerprinting. In addition to the gravity direction an estimate of the mobile/wearable device heading may be needed, which is prone to estimation errors, especially due to the inherent drift of gyroscope sensor signal information. Consequently, the use of azimuth information for geomagnetic fingerprinting is typically limited to specific applications, e.g. for localization of robots. The sensors are typically fixed to the body of the robot which simplifies the estimation process and hence reduces the amount of estimation errors. Often, the z-coordinate is already aligned to the gravity direction, sensor heading and motion heading have a fixed relation, so that there is no need for step and step length estimation, etc.

FIG. 2 shows a schematic diagram of a first embodiment of an orientation determination device 10 according to the present disclosure.

The orientation determination device 10 comprises data input circuitry 11 configured to obtain magnetic field sensor data 101 comprising at least two magnetic field measurements sensed by one or more magnetic field sensors 20 (in this embodiment not part of the device 10) at spatially separate positions and/or in separate frequency ranges and/or at different times and/or at different codes. Generally, the magnetic field sensor data 101 have been measured in sensor coordinates. The data input circuitry 11 may be represented by a data interface, e.g. an interface (such as a HDMI, USB, network interface, etc.) for data reception or retrieval, to receive or retrieve the magnetic field sensor data 101 directly from the one or more magnetic field sensors 20 or from a storage means (e.g. a data carrier, an electronic memory, a buffer, etc.; not shown) where the magnetic field sensor data 101 are stored or buffered.

The orientation determination device 10 further comprises a position input circuitry 12 configured to obtain a position estimate 102 of the one or more positions of the one or more magnetic field sensors 20, at which the magnetic field sensor data have been acquired. The position input circuitry 12 may also be represented by a separate data interface, e.g. an interface (such as a HDMI, USB, network interface, etc.) for data reception or retrieval, to receive or retrieve the position estimate 102 e.g. from an internal or external position estimation circuitry 30, or may be combined with the data input circuitry 11 into a common interface.

The orientation determination device 10 further comprises an estimation circuitry 13 configured to derive, from a magnetic map 103, azimuth and inclination data at the one or more positions of the one or more magnetic field sensors indicated by the obtained position estimate and to estimate the orientation of the orientation determination device based on the obtained magnetic field sensor data and the azimuth and inclination data derived from the magnetic map 103. Generally, the azimuth and inclination data are available in a reference coordinate system. The magnetic map 103 is generally acquired in advance and e.g. provided by a service provider, the owner or operator of a building in which the orientation determination shall be used, etc., and may be stored in a storage means (not shown; in this embodiment not being part of the device 10) or provided by a server 40 (generally not being part of the device 10), e.g. via the internet or another network. For example, a user may download a magnetic map of a location he wants to visit, or a suitable magnetic map may be downloaded or provided automatically based on current position information of (a device comprising or connected to) the one or more magnetic field sensors 20 (like GPS information obtained before entering a building, or upon detection of a Bluetooth beacon placed at an entry of a building etc.). The estimation circuitry 13 may e.g. be implemented in hard- and/or software, e.g. an appropriately programmed processor or computer.

Thus, according to the present disclosure it is possible to determine the orientation of the orientation determination device 10 in the reference coordinate system, i.e. in 3D coordinates, without much hard- and software efforts. Particularly if the x and y axes of the magnetic field sensor(s) are lying in a horizontal plane (e.g. if the magnetic field sensor(s) is (are) attached to a mobile robot), the comparison of the sensed magnetic field's azimuth against the magnetic map azimuth at this location directly provides the absolute heading of the device with respect to the reference coordinate system used to record the magnetic map. In the more general case the device can possess an arbitrary orientation in 3D space.

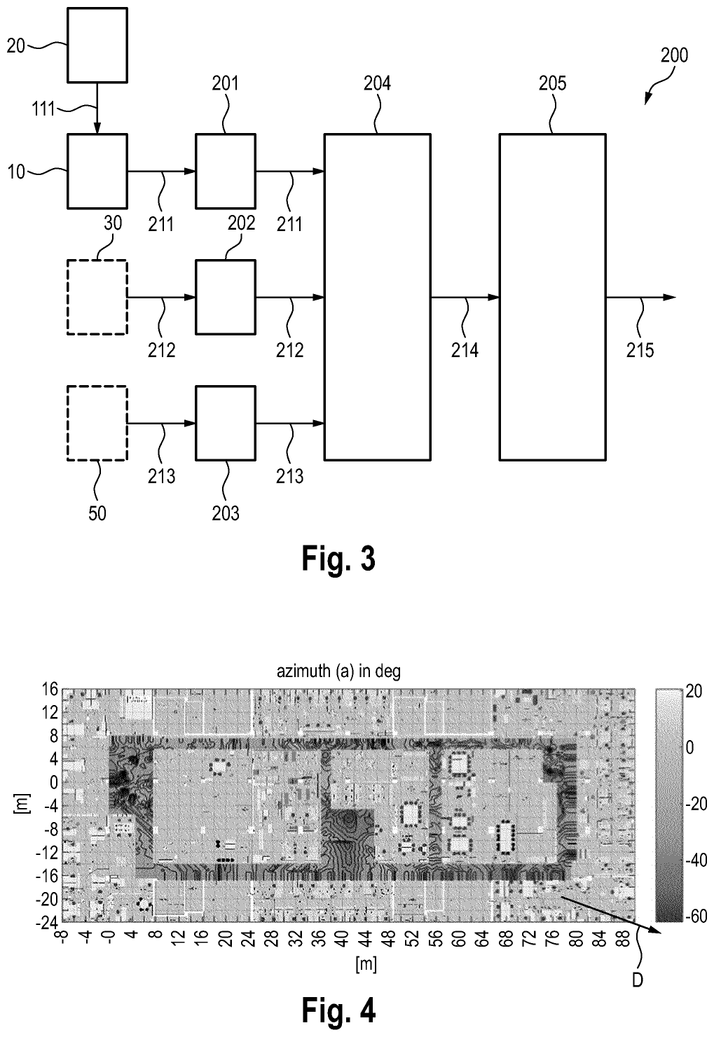

FIG. 3 shows a schematic diagram of a first embodiment of a rendering device 200 according to the present disclosure. The rendering device 200 may e.g. be a handheld device, a wearable device, a mobile phone, a smartphone, a portable phone, a camera, a smart watch, a vital signs monitor, a laptop, a tablet, smart glasses, headphones, earphones or any other portable device that may be carried around by a user.

The rendering device 200 comprises one or more magnetic field sensors 20 configured to sense magnetic field sensor data comprising at least two magnetic field measurements sensed at spatially separate positions and/or in separate frequency ranges and/or at different times and/or at different codes. The rendering device 200 further comprises an orientation determination device 10 as disclosed herein, e.g. in FIG. 2, to determine orientation information indicating the orientation of the rendering device.

The rendering device 200 further comprises an orientation input circuitry 201 configured to obtain orientation information 211 indicating the orientation of the rendering device 200. The orientation information 211 is obtained from the orientation determination device 10. The rendering device 200 further comprises a position input circuitry 202 configured to obtain a position estimate 212 of the rendering device 200, e.g. for retrieval or reception of the position estimate from an internal or external position estimation circuitry 30. The rendering device 200 further comprises a target position input circuitry 203 configured to obtain target position information 213 indicating a target position of one or more targets, e.g. from a target information storage or server 50 (generally not being part of the rendering device 200). The target may e.g. be virtual sound source, a virtual light source or any physical target, such as a certain location (e.g. a place that a user wants to reach like a certain department in a shopping mall or office building, a meeting area in a large building, a certain place of production in a large factory, etc.). The orientation input circuitry 201, the position input circuitry 202 and the target position input circuitry 203 may be represented by separate data interfaces or a common interface, e.g. an interface (such as a HDMI, USB, network interface, etc.) for data reception or retrieval.

The rendering device 200 further comprises a relative target position determination circuitry 204 configured to determine the relative position 214 of the one or more targets with respect to the rendering device 200 based on the orientation information 211, the obtained position estimate 212 and the obtained target position information 213. Finally, the rendering device 200 further comprises rendering circuitry 205 configured to render target information 215 related to the one or more targets using the determined relative position 214 of the one or more targets.

With the disclosed rendering device the heading and/or orientation, preferably including a distance and direction estimate, can be used for different applications, such as enhanced compass-like navigation to a target or realization of virtual sound sources (targets) in a 2D/3D area independent of the user or device position and orientation, i.e. the realization of sound sources that appear in static locations independent of head orientation and user position and thus give the impression of an augmented reality sound.

According to the above disclosed embodiments an estimate of the position of the magnetic field sensor (FIG. 2) and the rendering device (FIG. 3), respectively, is used. Generally, it is not relevant how this estimate is determined. Internal or external means may be provided for this purpose. In the embodiments shown in FIGS. 2 and 3 position estimation circuitry 30 is provided as external component that supplies the position estimate. In other embodiments the position estimation circuitry 30 is an internal component of the heading determination device 10 and the rendering device 200, respectively.

The (external or internal) position estimation circuitry 30 may be configured to estimate the position of the one or more magnetic field sensors 20 based on non-magnetic information, e.g. from a communication system, WiFi access points or (e.g. Bluetooth) beacons or ultra-wideband systems. Geomagnetic fingerprinting using the obtained magnetic field sensor data 101 and the magnetic map 103 may also be used by the position estimation circuitry 30 provided as part of the heading determination device 10. Assuming magnetic fingerprinting for localization, at least the magnitude (and optionally the inclination) of the magnetic field should be additionally considered to obtain reliable position estimates. Alternatively or additionally inclination, horizontal and/or vertical magnetic field components (with respect to earth coordinates) can be used to improve the position estimate. Moreover, a complementary technology may be used to obtain a unique location estimate from the geomagnetic field. One possibility is to use (pedestrian) dead reckoning (PDR) based on accelerometer and gyroscope data from on-device sensors, as proposed according to another embodiment.

The location of the orientation determination device can be either obtained by some non-magnetic localization system (e.g. Wi-Fi access points, Bluetooth beacons, ultra-wideband systems) or by means of magnetic fingerprinting. Assuming magnetic fingerprinting for localization, at least the magnitude of the magnetic field should be additionally considered to obtain reliable position estimates. Alternatively or additionally inclination, horizontal and/or vertical magnetic field components (with respect to earth coordinates) can be used to improve the position estimate. Moreover, a complementary technology may be required to obtain a unique location estimate from the geomagnetic field. One possibility is to use (pedestrian) dead reckoning ((P)DR) based on accelerometer and gyroscope data from on-device sensors, as proposed according to another embodiment.

The magnetic map 103 should contain at least the location-dependent azimuth of the (distorted) magnetic field with respect to a given reference coordinate system (e.g. the earth coordinate system) to obtain a 2D heading estimate. FIG. 4 shows an example of a magnetic map recorded in an office building. Here, the coordinate reference system's heading (0 heading) is with respect to the axis of abscissae (x-axis). The example shows the distortions of the azimuth of the magnetic field (magnetic north with respect to the earth coordinates corresponds to −22° as indicated by the arrow D in FIG. 4): The compass heading of the device would be distorted if the azimuth is different from −22°.

Particularly if the x- and y-axes of the one or more magnetic field sensors 20 are known to be lying in a horizontal plane (e.g. if the one or more sensors 20 are attached to a mobile robot), the comparison of the sensed magnetic field's azimuth against the magnetic map azimuth at this location directly provides the absolute heading of the one or more sensors 20 (and of a device incorporating the one or more sensors 20, e.g. a user device such as a smartphone) with respect to the reference coordinate system used to record the magnetic map. The corresponding block diagram of the device is depicted in FIG. 3.

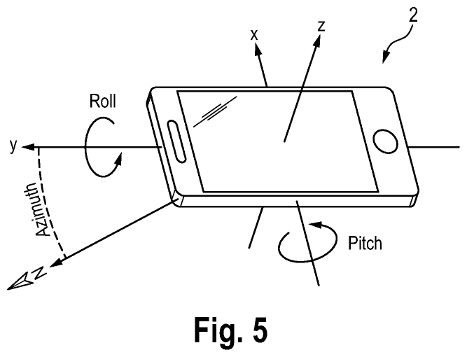

In the more general case the device (in particular the magnetic field sensor) can possess an arbitrary orientation in 3D space. FIG. 5 shows a diagram illustrating device orientation by way of a smartphone 2 embedding the disclosed rendering system. This diagram explains the definitions of the orientation by means of three angles (roll, pitch and healing). Other representations of the orientation may be possible as well (e.g. by means of a freely defined rotation axis and angle as used in the following mathematical derivations). The roll/pitch information might be used for 3D rendering information (e.g. to derive 3D positions of virtual sound sources, as will be explained in more detail below). In case only the heading information 107 is used, mainly a 2D rendering is possible.

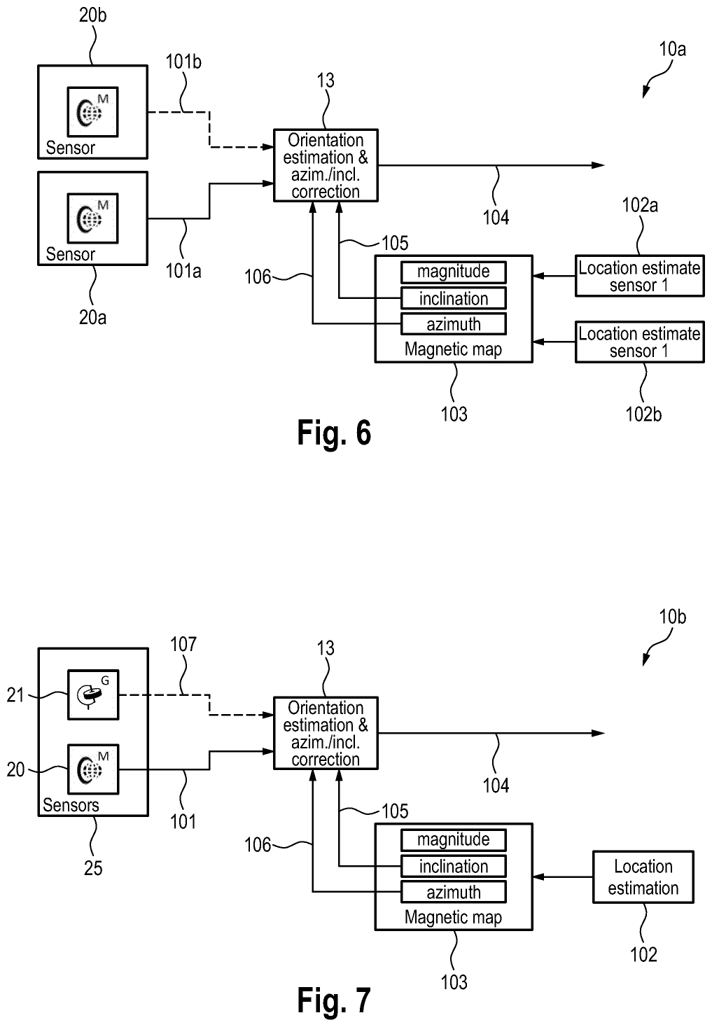

In order to estimate the 3D orientation of the device, a magnetic map that contains azimuth and inclination information of the magnetic field given with respect to a coordinate system, e.g. the earth coordinate system. Due to the rotational symmetry of a 3D magnetic field vector around its own axis a single magnetic field vector may not be sufficient to obtain the sensor's orientation. Thus, at least two 3-dimensional magnetic field vectors pointing into different directions may be used. Different options exist to obtain multiple 3D magnetic field vectors, which are used is different embodiments of an orientation determination device illustrated in FIGS. 6-9. In these figures the interfaces (i.e. input circuitries 11 and 12) have been left out for simplification of the illustration.

FIG. 6 shows a schematic diagram of a second embodiment of an orientation determination device 10a according to the present disclosure. In this embodiment the 3D magnetic field is measured with at least two locally separated magnetic field sensors 20a, 20b at the same time with both sensors 20a, 20b pointing into the same direction (or with known orientation offset to each other). This can be e.g. realized by attaching both sensors to a rigid rod. Thus, two magnetic field measurements 101a, 101b are used by the estimation circuitry 13 to determine the orientation 104 of the device 10a. Position estimates 102a, 102b of the positions of the two magnetic field sensors 20a, 20b are used to select the inclination information 105 and azimuth information 106 from the magnetic map 103 at these positions for use by the estimation circuitry 13.

FIG. 7 shows a schematic diagram of a third embodiment of an orientation determination device 10b according to the present disclosure. In this embodiment the 3D magnetic field is measured with a single magnetic field sensor 20 at different time instances. The time interval between these measurements should be large enough to ensure that the position has sufficiently (e.g. more than 0.5 or 1 m) changed during this time interval. This can e.g. be achieved by ensuring that the orientation of the sensor remains fixed during the time interval or by tracking the change in orientation between both measurements, e.g. by means of a gyroscope 21, which may form a common sensor unit 25 together with the magnetic field sensor 20 and provides such tracking data 107. In order to avoid accumulating orientation estimation errors, the time interval between both measurements should be sufficiently short, for example within several seconds for today's sensors. Hereby, the allowed time frame strongly depends on sensor quality (e.g. bias) and can be in fact much longer for high quality (e.g. military application) sensors.

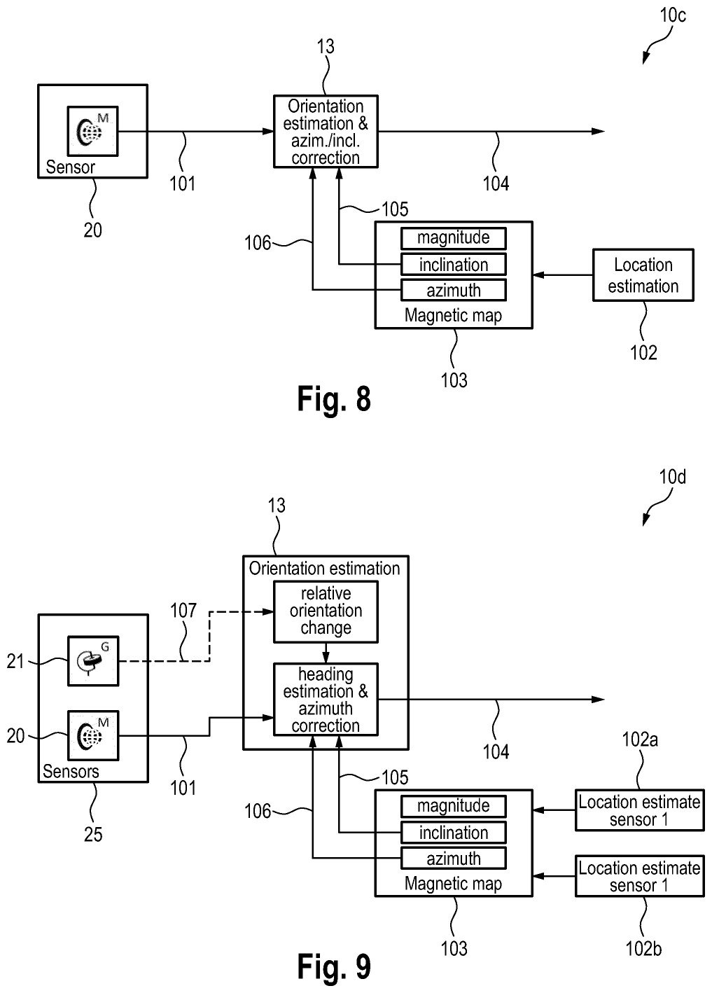

FIG. 8 shows a schematic diagram of a fourth embodiment of an orientation determination device 10c according to the present disclosure. In this embodiment multiple 3D magnetic field vectors are measured at the same time (and possibly with the same sensor 20), e.g. the geomagnetic field and a magnetic beacon signal which are separable in the frequency domain by appropriate filtering. Alternatively or additionally, multiple 3D magnetic field vectors may be measured at different times (and possibly with the same sensor 20), e.g. the geomagnetic field and one or more magnetic beacon signals, wherein the one or more beacon signals are time-multiplexed and separable in the time domain by appropriate time demultiplexing and/or by (prior or acquired) knowledge of the timing (e.g. periodicity) of the beacon signals. Still further, in an embodiment, multiple 3D magnetic field vectors may be measured at different (e.g. orthogonal) codes (and possibly with the same sensor 20), e.g. the geomagnetic field and one or more magnetic beacon signals, wherein the one or more beacon signals are code-multiplexed and separable based on the code used by appropriate code demultiplexing. In every case, for a 3D orientation estimation two vector measurements with corresponding reference vectors are generally needed, wherein the reference vectors have a different direction to avoid ambiguities in the 3D orientation estimate. This is independent of how these vectors are measured or what is causing the measured magnetic fields.

FIG. 9 shows a schematic diagram of a fifth embodiment of an orientation determination device 10d according to the present disclosure. In this embodiment a 3D orientation estimate based on two spatially or in frequency separated measurements of the magnetic field. The idea behind is to estimate the rotation matrix R that maps the measured 3D magnetic field vectors onto the corresponding magnetic map 3D vector. Provided that this estimation can be performed without ambiguity, the sensor orientation 104 can be obtained from the inverse rotation Γ=R⁻¹ of the magnetic map coordinate reference system.

There exist different ways to define a rotation in 3D space (e.g. rotation matrices or quaternions). In the following mathematical derivation the rotation is defined in terms of a normalized 3D rotation axis n=[n₁ n₂ n₃]^{T} and a rotation around n by angle α. In Cartesian representation the corresponding rotation matrix is defined as

$$R ( n , α ) = [ \begin{matrix}cos ( α ) + {n}_{1}^{2} ( 1 - cos ( α ) ) & {n}_{1} {n}_{2} ( 1 - cos ( α ) ) - {n}_{3} sin ( α ) & {n}_{1} {n}_{3} ( 1 - cos ( α ) ) + {n}_{2} sin ( α ) \\ {n}_{2} {n}_{1} ( 1 - cos ( α ) ) + {n}_{3} sin ( α ) & cos ( α ) + {n}_{2}^{2} ( 1 - cos ( α ) ) & {n}_{2} {n}_{3} ( 1 - cos ( α ) ) - {n}_{1} sin ( α ) \\ {n}_{3} {n}_{1} ( 1 - cos ( α ) ) - {n}_{2} sin ( α ) & {n}_{3} {n}_{2} ( 1 - cos ( α ) ) + {n}_{1} sin ( α ) & cos ( α ) + {n}_{3}^{2} ( 1 - cos ( α ) )\end{matrix} ]$$

For the sake of explanation, it is assumed that only two locally (or in some other domain) separated 3D magnetic field measurements m_{s,1} and m_{s,2} (in sensor coordinates) are made where each measurement can be related to a distinct magnetic map entry m_{p,1} and m_{p,2} (in earth coordinates), respectively. The relative rotation R(nᵣₑₗ, αᵣₑₗ) between sensor measurements 1 and 2 is either fixed or can be obtained from the gyroscope. It describes the relation between both sensor measurements, i.e. how m_{s,2} is represented in the orientation of the sensor used to obtain m_{s,1}:

\tilde{m}_{s,2}=R(nᵣₑₗ,αᵣₑₗ)m_{s,2}

In the most simple case, m_{s,1} and m_{s,2} are measured at the same time instant with different sensors which fixed to a rigid rod and both sensors are perfectly aligned in their axes. In this case Rᵣₑₗ=I₃.

Starting e.g. with \tilde{m}_{s,2}, the rotation matrix R(n₂,α₂) that maps \tilde{m}_{s,2} to m_{p,2} is computed, i.e. m_{p,2}=R(n₂,α₂)\tilde{m}_{s,2} where

n₂=\tilde{m}_{s,2}×m_{p,2}/|\tilde{m}_{s,2}×m_{p,2}|

α₂=cos⁻¹(\tilde{m}_{s,2}^{T}m_{p,2}/(|\tilde{m}_{s,2}∥m_{p,2}|)).

It should be noted that this rotation matrix still does not represent a unique solution due to the rotational symmetry of 3D vectors, in this case m_{p,2}. Next, m_{s,1} is rotated according to

\tilde{m}_{s,1}=R(n₂,α₂)m_{s,1}.

In most cases it will be observed that \tilde{m}_{s,1} still does not match with m_{p,1} due to the aforementioned ambiguity. Thus, the final mapping may be achieved by another rotation around the ambiguity rotation axis given by the normalized vector

n₁=−m_{p,2}/|m_{p,2}|.

In order to obtain the rotation angle, the projection x₀ of m_{p,1} on m_{p,2} is projected:

$${x}_{0} = \frac{{m}_{p , 2}^{T} {m}_{p , 1}}{{m}_{p , 2}^{T} {m}_{p , 2}} , {m}_{p , 2} ,$$

and then derive the rotation angle α₁ as the angle between the vectors vₛ=\tilde{m}_{s,1}−x₀ and

vₚ=m_{p,1}−x₀:

α₁=cos⁻¹(vₛ^{T}vₚ/(|vₛ∥vₚ|)).

Finally, multiplication of both estimated rotation matrices yields the final rotation matrix that describes the orientation of the device/sensor with respect to the reference coordinate system:

Γ=R(n₁,α₁)R(n₂,α₂).

It should be noted that the derivation above includes some degrees of freedom, e.g. one could also use m_{s,1} as starting point instead of \tilde{m}_{s,2} or the relative rotation R(nᵣₑₗ,αᵣₑₗ) could describe how m_{s,1} is represented in the orientation of the sensor used to obtain m_{s,2}. The subsequent computation steps will change accordingly.

If more than two magnetic field measurements and corresponding position-related magnetic map entries are available, a weighted averaging can be applied to increase the accuracy of the orientation estimate. Especially the rotation angle estimation of the second rotation is prone to errors caused by noisy sensor signals and/or inaccurate position estimates used to look up the magnetic map entries. The shorter the vectors vₛ and/or vₚ are, the less reliable the heading estimate based on magnetic field information. It is thus proposed in another embodiment to use the vector length |vₛ| or |vₚ| or any mathematical function thereof as weight information for the magnetic field heading estimate in a joint heading estimation process based on gyroscope and magnetic field information. Exemplary weights w are:

(|vₛ|)=|vₛ|/|\tilde{m}ₛ|

w(|vₚ|)=|vₚ|/|mₚ|

w(|vₛ|)=|vₛ|²/σₛ² with sensor noise variance σₛ²

w(|vₛ|,|vₚ|)=min(|vₛ|,|vₚ|)).

Many orientation algorithms using gyroscope and magnetic sensors (and potentially accelerometer) are based on an adaptive design (i.e. new orientation estimates are obtain based on the previous orientation estimate and the new incoming sensor data). Typically, a weighting factor β controls the weight between the relative update based on the gyroscope and the absolute update based on the magnetometer (and potentially accelerometer). We propose to make this weighting factor β dependent on the above factor w.

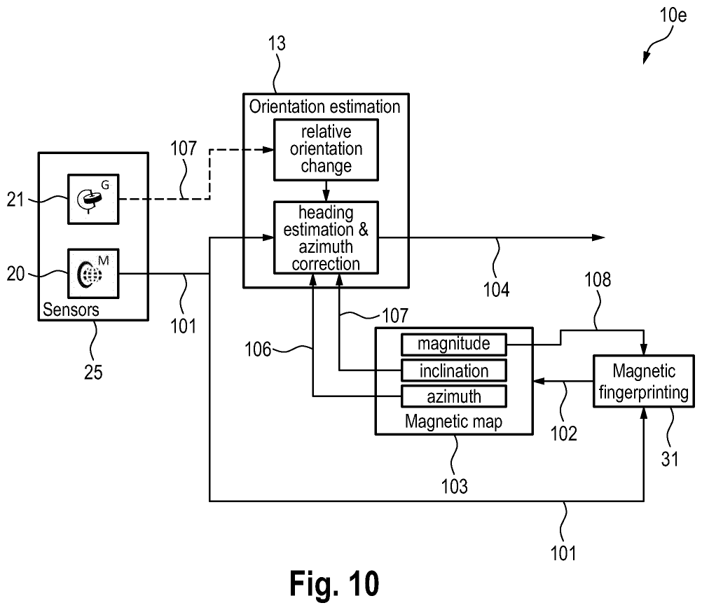

FIG. 10 shows a schematic diagram of a sixth embodiment of an orientation determination device 10e according to the present disclosure where magnetic fingerprinting is used for both orientation and location estimation. Here, the location in a magnetic fingerprinting unit 31 is estimated by comparing the current magnetic measurement 101 with the magnetic field data, in particular the magnitude 108 of the magnetic field, taken from the magnetic map 103. If the 3D orientation estimation is based on only the magnetic field sensor, only the magnitude 108 can be used for fingerprinting, as the inclination information is used already for the orientation estimation and this degree of freedom may not be used twice. In case of 2D heading estimation or with roll/pitch estimation the inclination might be used as well for position estimation using magnetic fingerprinting.

The devices and methods according to the present disclosure are especially suited for mobile and wearable devices due to today's availability of the required sensors (accelerometer, gyroscope, and magnetometer) in such devices and its low power consumption compared to other technologies such as Visual SLAM or wideband MIMO systems. The target(s) can be either indoor or outdoor, whereas the device is located indoor. Example applications are enhanced compass, which shows the relative distance and direction to target(s), and sound augmented reality (AR), according to which a virtual sound source is created at a specific location (or trajectory for moving targets) independent of the mobile device (user) location and heading.

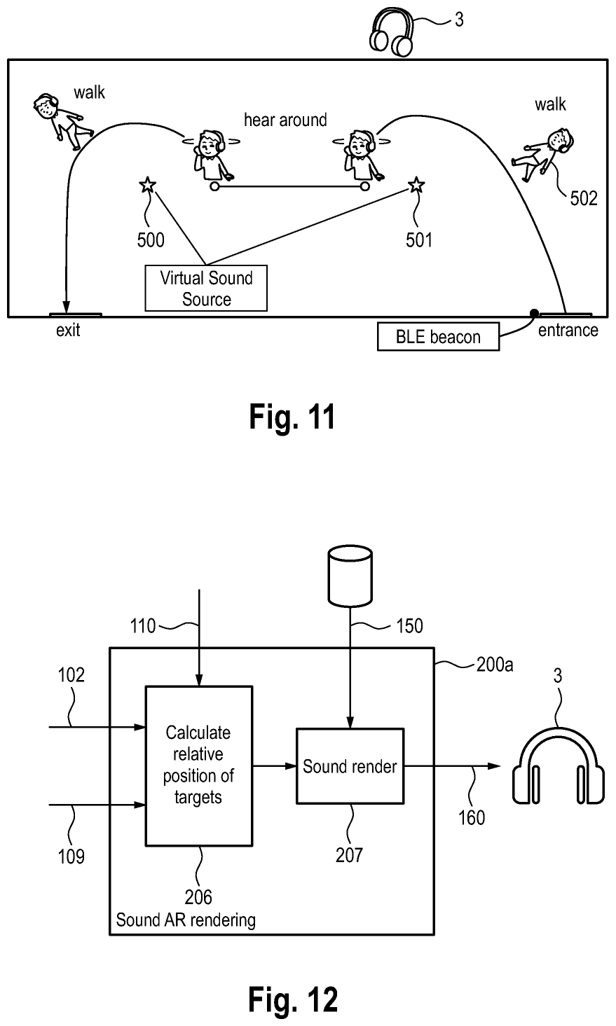

The rendering process described above will now be explained in more detail for two different embodiments illustrated in FIGS. 11 and 12. FIG. 11 shows a diagram illustrating a sound AR application; FIG. 12 shows a diagram illustrating a corresponding embodiment of a rendering device 200a (the interfaces are not shown) for use in this application scenario, which may be embedded in a headphone 3. The position of the target(s), represented by the target information 110, corresponds to the virtual sound sources 500, 501 in this embodiment. In a first step, the relative position of the sound sources 500, 501 is calculated in a computation unit 206 based on the position estimate 102 and the orientation (or heading) information 109 of the user 502 and the position of the sound sources 500, 501. Next, the audio signals 150 of the sound sources 500, 501 and the position 110 of the sound sources 500, 501 relative to the user's position and orientation are used in a sound renderer 207 (e.g. Dolby surround or any other surround sound system) to generate the sound signals 160 to be played back by the headphones 3. A beacon, e.g. a BLE (Bluetooth low energy) beacon at the entrance (and optionally exit) may be used to notice that a user enters the area in which this application scenario shall be used.

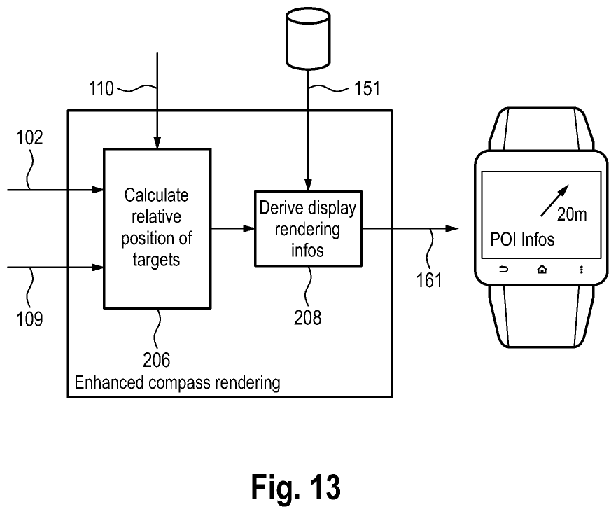

FIG. 13 shows a schematic diagram of a third embodiment of a rendering device 200b according to the present disclosure for use in a second application scenario, in particular for an enhanced compass application. Here, the position of the targets may correspond to any point(s) of interest (e.g. a certain store, product, Pokémon, treasure (gaming), person, etc.). Again, the relative position of the target(s) is calculated based on the position estimate 102 and the orientation (or heading) information 109 of the user and the position of the targets represented by the target information 110. Based on this result, some display information 161 by the display renderer 208 is derived, e.g. the heading towards the target relative to the device orientation (e.g. smartwatch or smartphone) and the distance. This information may be combined with some additional information 151 about the target to be illustrated on the display of e.g. the mobile device.

In another embodiment both applications may be combined to realize navigation by “follow sound source”. Here, virtual sound sources guide the user in the direction of the point of interest, e.g. where the sound source appears at the location of the target itself (or direction of the target e.g. 5m away from the user).

The targets may be selected based on the current position estimate, e.g. by approaching a certain exhibition object in a museum some audio information is played back coming from the exhibition object. Also, the targets may move, e.g. some narrator is explaining something while walking (the voice appears to your right hand side as if a person is walking beside you, etc.). In case of the navigation by “follow sound source” the sound source may change depending on the user's current position, e.g. the sound appears in front of user in order to guide the user in the right direction. The sound source is updated to follow the navigation path: typically, the direct way to the target is not possible and the user has to follow some hallways or move around corners, etc.

Essential advantages can be achieved by the present disclosure:
absolute heading (with respect to defined reference coordinate system) can be directly obtained from comparison of magnetic field measurement(s) with the location-specific magnetic map entry/entries (azimuth/orientation correction);
magnetic map magnitude can be independently used to get position information based on magnetic fingerprinting;
low power solution to obtain position and orientation information in buildings;
required sensors (gyroscope, magnetometer) are widely available in today's mobile and wearable devices;
no dedicated infrastructure required in the building (magnetic map of building is sufficient).

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriated circuits. A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit includes the above-described hardware executing software.

It follows a list of further embodiments of the disclosed subject matter:

1. An orientation determination device comprising:
data input circuitry configured to obtain magnetic field sensor data comprising at least two magnetic field measurements sensed by one or more magnetic field sensors at spatially separate positions and/or in separate frequency ranges and/or at different times and/or at different codes,
position input circuitry configured to obtain a position estimate of the one or more positions of the one or more magnetic field sensors at which the magnetic field sensor data have been acquired, and
estimation circuitry configured to derive, from a magnetic map, azimuth and inclination data at the one or more positions of the one or more magnetic field sensors indicated by the obtained position estimate and to estimate the orientation of the orientation determination device based on the obtained magnetic field sensor data and the azimuth and inclination data derived from the magnetic map.

2. The orientation determination device as defined in embodiment 1,

wherein said estimation circuitry is configured to determine a rotation matrix that maps the obtained magnetic field sensor data onto the azimuth and inclination data derived from the magnetic map and to estimate the orientation of the orientation determination device by use of the inverse of the estimated rotation matrix.

3. The orientation determination device as defined in embodiment 2,

wherein said estimation circuitry is configured to define the rotation matrix using a normalized 3D rotation axis and a rotation around the normalized 3D rotation axis by a rotation angle.

4. The orientation determination device as defined in embodiment 3,

wherein said estimation circuitry is configured to define the rotation matrix R using a normalized 3D rotation axis n=[n₁ n₂ n₃]^{T} and a rotation around the normalized 3D rotation axis n by a rotation angle α as

$$R ( n , α ) = [ \begin{matrix}cos ( α ) + {n}_{1}^{2} ( 1 - cos ( α ) ) & {n}_{1} {n}_{2} ( 1 - cos ( α ) ) - {n}_{3} sin ( α ) & {n}_{1} {n}_{3} ( 1 - cos ( α ) ) + {n}_{2} sin ( α ) \\ {n}_{2} {n}_{1} ( 1 - cos ( α ) ) + {n}_{3} sin ( α ) & cos ( α ) + {n}_{2}^{2} ( 1 - cos ( α ) ) & {n}_{2} {n}_{3} ( 1 - cos ( α ) ) - {n}_{1} sin ( α ) \\ {n}_{3} {n}_{1} ( 1 - cos ( α ) ) - {n}_{2} sin ( α ) & {n}_{3} {n}_{2} ( 1 - cos ( α ) ) + {n}_{1} sin ( α ) & cos ( α ) + {n}_{3}^{2} ( 1 - cos ( α ) )\end{matrix} ] .$$

5. The orientation heading determination device as defined in any one of the preceding embodiments 2 to 4,

wherein said estimation circuitry is configured to determine the rotation matrix by use of the relative rotation between the obtained magnetic field measurements.

6. The orientation heading determination device as defined in embodiment 5,

wherein said data input circuitry is configured to obtain magnetic field sensor data comprising magnetic field measurements sensed by at least two magnetic field sensors at spatially separate positions, wherein the relative position and orientation of said at least two magnetic field sensors is fixed or known, and

wherein said estimation circuitry is configured to determine the relative rotation between the obtained magnetic field measurements from the fixed or known relative position and orientation of said at least two magnetic field sensors.

7. The orientation heading determination device as defined in any one of the preceding embodiments 5 and 6,

wherein said data input circuitry is configured to obtain magnetic field sensor data comprising magnetic field measurements sensed by a single magnetic field sensor at different time instances and at spatially separate positions, wherein the orientation of the magnetic field sensor at said spatially separate positions is fixed or tracked by an orientation sensor, and

wherein said estimation circuitry is configured to determine the relative rotation between the obtained magnetic field measurements from the fixed or tracked orientation of said magnetic field sensor.

8. The orientation heading determination device as defined in any one of the preceding embodiments,

wherein said data input circuitry is configured to obtain magnetic field sensor data comprising magnetic field measurements sensed by a single magnetic field sensor in separate frequency ranges and/or at different times and/or at different codes, wherein one of said magnetic field measurements represents a magnetic beacon signal in a frequency range used by one or more magnetic beacons and/or emitted at a time used by one or more magnetic beacons and/or with a code used by one or more magnetic beacons.

9. The orientation heading determination device as defined in any one of the preceding embodiments,

wherein said estimation circuitry is configured to determine a separate rotation matrix for each magnetic field measurement that maps the respective magnetic field measurement onto the azimuth and inclination data derived from the magnetic map and to estimate the orientation of the orientation determination device by use of the product of the separate rotation matrices.

10. The orientation determination device as defined in any one of the preceding embodiments,

further comprising position estimation circuitry configured to estimate the position of the magnetic field sensor.

11. The orientation determination device as defined in embodiment 10, wherein said position estimation circuitry is configured to estimate the position of the magnetic field sensor based on information from a communication system, WiFi access points or beacons and/or based on geomagnetic fingerprinting using the obtained magnetic field sensor data and the magnetic map.

12. The orientation determination device as defined in any one of the preceding embodiments 10 and 11,

wherein said position estimation circuitry is configured to estimate the position of the magnetic field sensor based on magnitude and/or inclination included in or derived from the obtained magnetic field sensor data and/or based on an inclination estimate indicating the inclination of the magnetic field sensor.

13. A rendering device comprising:
one or more magnetic field sensors configured to sense magnetic field sensor data comprising at least two magnetic field measurements sensed at spatially separate positions and/or in separate frequency ranges and/or at different times and/or at different codes, and
an orientation determination device as defined in any one of the preceding embodiments 1 to determine orientation information indicating the orientation of the rendering device,
position input circuitry configured to obtain a position estimate of the rendering device,
target position input circuitry configured to obtain target position information indicating a target position of one or more targets,
relative target position determination circuitry configured to determine the relative position of the one or more targets with respect to the rendering device based on the orientation information, the obtained position estimate and the obtained target position information, and
rendering circuitry configured to render target information related to the one or more targets using the determined relative position of the one or more targets.

14. The rendering device as defined in any one of the preceding embodiments 13,

wherein the target positions of one or more targets are positions of virtual sound sources and wherein said rendering circuitry is configured to render audio signals in a way as if they were rendered at the position of said virtual sound sources.

15. The rendering device as defined in embodiment 13,

wherein said rendering circuitry is configured to render display information indicating distance and/or direction to one or more of said targets.

16. The rendering device as defined in any one of the preceding embodiments 13 to 15,

further comprising target selection circuitry configured to select one or more targets based on the position estimate of the rendering device.

17. The rendering device as defined in any one of the preceding embodiments 13 to 16,

wherein said target position input circuitry is configured to continuously, regularly or occasionally obtain a new target position.

18. The rendering system as defined in any one of the preceding embodiments 13 to 17,

further comprising an accelerometer configured to acquire accelerometer data and/or a gyroscope configured to acquire gyroscope data.

19. An orientation determination method comprising:
obtaining magnetic field sensor data comprising at least two magnetic field measurements sensed by one or more magnetic field sensors at spatially separate positions and/or in separate frequency ranges and/or at different times and/or at different codes,
obtaining a position estimate of the one or more positions of the one or more magnetic field sensors, at which the magnetic field sensor data have been acquired, and
deriving, from a magnetic map, azimuth and inclination data at the one or more positions of the one or more magnetic field sensors indicated by the obtained position estimate, and
estimating the orientation of the orientation determination device based on the obtained magnetic field sensor data and the azimuth and inclination data derived from the magnetic map.

20. A rendering method comprising:
sensing magnetic field sensor data comprising at least two magnetic field measurements sensed at spatially separate positions and/or in separate frequency ranges and/or at different times and/or at different codes, and
determining orientation information indicating the orientation of the rendering device by an orientation determination method as defined in embodiment 19,
obtaining a position estimate of the rendering device,
obtaining target position information indicating a target position of one or more targets,
determining the relative position of the one or more targets with respect to the rendering device based on the orientation information, the obtained position estimate and the obtained target position information, and
rendering target information related to the one or more targets using the determined relative position of the one or more targets.

21. A non-transitory computer-readable recording medium that stores therein a computer program product, which, when executed by a processor, causes the method according to embodiment 19 or 20 to be performed.

22. A computer program comprising program code means for causing a computer to perform the steps of said method according to embodiment 19 or 20 when said computer program is carried out on a computer.

1. An orientation determination device comprising:
data input circuitry configured to obtain magnetic field sensor data comprising at least two magnetic field measurements sensed by one or more magnetic field sensors at spatially separate positions and/or in separate frequency ranges and/or at different times and/or at different codes,
position input circuitry configured to obtain a position estimate of the one or more positions of the one or more magnetic field sensors at which the magnetic field sensor data have been acquired, and
estimation circuitry configured to derive, from a magnetic map, azimuth and inclination data at the one or more positions of the one or more magnetic field sensors indicated by the obtained position estimate and to estimate the orientation of the orientation determination device based on the obtained magnetic field sensor data and the azimuth and inclination data derived from the magnetic map.

2. The orientation determination device as claimed in claim 1,
wherein said estimation circuitry is configured to determine a rotation matrix that maps the obtained magnetic field sensor data onto the azimuth and inclination data derived from the magnetic map and to estimate the orientation of the orientation determination device by use of the inverse of the estimated rotation matrix.

3. The orientation determination device as claimed in claim 2,
wherein said estimation circuitry is configured to define the rotation matrix using a normalized 3D rotation axis and a rotation around the normalized 3D rotation axis by a rotation angle.

4. The orientation determination device as claimed in claim 3,
wherein said estimation circuitry is configured to define the rotation matrix R using a normalized 3D rotation axis n=[n₁ n₂ n₃]^{T} and a rotation around the normalized 3D rotation axis n by a rotation angle α as
$$R ( n , α ) = [ \begin{matrix}cos ( α ) + {n}_{1}^{2} ( 1 - cos ( α ) ) & {n}_{1} {n}_{2} ( 1 - cos ( α ) ) - {n}_{3} sin ( α ) & {n}_{1} {n}_{3} ( 1 - cos ( α ) ) + {n}_{2} sin ( α ) \\ {n}_{2} {n}_{1} ( 1 - cos ( α ) ) + {n}_{3} sin ( α ) & cos ( α ) + {n}_{2}^{2} ( 1 - cos ( α ) ) & {n}_{2} {n}_{3} ( 1 - cos ( α ) ) - {n}_{1} sin ( α ) \\ {n}_{3} {n}_{1} ( 1 - cos ( α ) ) - {n}_{2} sin ( α ) & {n}_{3} {n}_{2} ( 1 - cos ( α ) ) + {n}_{1} sin ( α ) & cos ( α ) + {n}_{3}^{2} ( 1 - cos ( α ) )\end{matrix} ] .$$

5. The orientation heading determination device as claimed in claim 2,
wherein said estimation circuitry is configured to determine the rotation matrix by use of the relative rotation between the obtained magnetic field measurements.

6. The orientation heading determination device as claimed in claim 5,
wherein said data input circuitry is configured to obtain magnetic field sensor data comprising magnetic field measurements sensed by at least two magnetic field sensors at spatially separate positions, wherein the relative position and orientation of said at least two magnetic field sensors is fixed or known, and
wherein said estimation circuitry is configured to determine the relative rotation between the obtained magnetic field measurements from the fixed or known relative position and orientation of said at least two magnetic field sensors.

7. The orientation heading determination device as claimed in claim 5,
wherein said data input circuitry is configured to obtain magnetic field sensor data comprising magnetic field measurements sensed by a single magnetic field sensor at different time instances and at spatially separate positions, wherein the orientation of the magnetic field sensor at said spatially separate positions is fixed or tracked by an orientation sensor, and
wherein said estimation circuitry is configured to determine the relative rotation between the obtained magnetic field measurements from the fixed or tracked orientation of said magnetic field sensor.

8. The orientation heading determination device as claimed in claim 1,
wherein said data input circuitry is configured to obtain magnetic field sensor data comprising magnetic field measurements sensed by a single magnetic field sensor in separate frequency ranges and/or at different times and/or at different codes, wherein one of said magnetic field measurements represents a magnetic beacon signal in a frequency range used by one or more magnetic beacons and/or emitted at a time used by one or more magnetic beacons and/or with a code used by one or more magnetic beacons.

9. The orientation heading determination device as claimed in claim 1,
wherein said estimation circuitry is configured to determine a separate rotation matrix for each magnetic field measurement that maps the respective magnetic field measurement onto the azimuth and inclination data derived from the magnetic map and to estimate the orientation of the orientation determination device by use of the product of the separate rotation matrices.

10. The orientation determination device as claimed in claim 1,
further comprising position estimation circuitry configured to estimate the position of the magnetic field sensor.

11. The orientation determination device as claimed in claim 10,
wherein said position estimation circuitry is configured to estimate the position of the magnetic field sensor based on information from a communication system, WiFi access points or beacons and/or based on geomagnetic fingerprinting using the obtained magnetic field sensor data and the magnetic map.

12. The orientation determination device as claimed in claim 10,
wherein said position estimation circuitry is configured to estimate the position of the magnetic field sensor based on magnitude and/or inclination included in or derived from the obtained magnetic field sensor data and/or based on an inclination estimate indicating the inclination of the magnetic field sensor.

13. A rendering device comprising:
one or more magnetic field sensors configured to sense magnetic field sensor data comprising at least two magnetic field measurements sensed at spatially separate positions and/or in separate frequency ranges and/or at different times and/or at different codes, and
an orientation determination device as claimed in claim 1 to determine orientation information indicating the orientation of the rendering device,
position input circuitry configured to obtain a position estimate of the rendering device,
target position input circuitry configured to obtain target position information indicating a target position of one or more targets,
relative target position determination circuitry configured to determine the relative position of the one or more targets with respect to the rendering device based on the orientation information, the obtained position estimate and the obtained target position information, and
rendering circuitry configured to render target information related to the one or more targets using the determined relative position of the one or more targets.

14. The rendering device as claimed in claim 13,
wherein the target positions of one or more targets are positions of virtual sound sources and wherein said rendering circuitry is configured to render audio signals in a way as if they were rendered at the position of said virtual sound sources.

15. The rendering device as claimed in claim 13,
wherein said rendering circuitry is configured to render display information indicating distance and/or direction to one or more of said targets.

16. The rendering device as claimed in claim 13,
further comprising target selection circuitry configured to select one or more targets based on the position estimate of the rendering device and/or an accelerometer configured to acquire accelerometer data and/or a gyroscope configured to acquire gyroscope data.

17. The rendering device as claimed in claim 13,
wherein said target position input circuitry is configured to continuously, regularly or occasionally obtain a new target position.

18. An orientation determination method comprising:
obtaining magnetic field sensor data comprising at least two magnetic field measurements sensed by one or more magnetic field sensors at spatially separate positions and/or in separate frequency ranges and/or at different times and/or at different codes,
obtaining a position estimate of the one or more positions of the one or more magnetic field sensors, at which the magnetic field sensor data have been acquired, and
deriving, from a magnetic map, azimuth and inclination data at the one or more positions of the one or more magnetic field sensors indicated by the obtained position estimate, and
estimating the orientation of the orientation determination device based on the obtained magnetic field sensor data and the azimuth and inclination data derived from the magnetic map.

19. A rendering method comprising:
sensing magnetic field sensor data comprising at least two magnetic field measurements sensed at spatially separate positions and/or in separate frequency ranges and/or at different times and/or at different codes, and
determining orientation information indicating the orientation of the rendering device by an orientation determination method as claimed in claim 18,
obtaining a position estimate of the rendering device,
obtaining target position information indicating a target position of one or more targets,
determining the relative position of the one or more targets with respect to the rendering device based on the orientation information, the obtained position estimate and the obtained target position information, and
rendering target information related to the one or more targets using the determined relative position of the one or more targets.

20. A non-transitory computer-readable recording medium that stores therein a computer program product, which, when executed by a processor, causes the method according to claim 18 to be performed.
